(19) United States
(12) Patent Application Publication
(10) Pub. No.: US 2022/0155271 A1
(43) Pub. Date: May 19, 2022

(54) SYSTEMS AND METHODS FOR TESTING FLUIDIC NETWORKS

(71) Applicant: DIONEX SOFTRON GMBH, Germering (DE)

(72) Inventor: Martin Rendl, München (DE)

(73) Assignee: DIONEX SOFTRON GMBH, Germering (DE)

(21) Appl. No.: 17/521,677

(22) Filed: Nov. 8, 2021

(30) Foreign Application Priority Data
Nov. 17, 2020 (DE) 10 2020 130 302.5

(51) Int. Cl. G01N 30/88

(52) U.S. Cl. CPC G01N 30/88; G01N 2030/027; G01N 2030/889

(57) ABSTRACT

In a first aspect, the present invention relates to a method of testing a fluidic system. The method comprising applying a fluid with an input fluidic characteristic to the fluidic system, while the fluidic system is in a first configuration, and measuring an output fluidic characteristic. The method also comprises comparing the measured output fluidic characteristic to a reference. In a further aspect the present invention relates to a testing system configured for testing a fluidic system.

### CROSS-REFERENCE TO RELATED APPLICATIONS

This application claims the priority benefit under 35 U.S.C. § 119 to German Patent Application No. 10 2020 130 302.5, filed on Nov. 17, 2020, which application is hereby incorporated herein by reference in its entirety.

The herein described invention is related to the field of chromatography, such as liquid chromatography and particularly focusing on high performance liquid chromatography (HPLC). This technique is based on chromatographic separation. A sample is separated into a characteristic separation pattern by pumping the sample together with an elution solvent (both are also referred to as mobile phase) through a chromatographic column which contains a solid—i.e. the stationary phase. The analytes contained in the mobile phase interacts with this stationary phase. Depending on the intensity of interaction between stationary phase and the analytes, the analytes are retained to a characteristic degree. Thus, strong interaction of a particular analyte component with the stationary phase results in a delayed passage time compared to a component showing only weak interaction. This results in components of the sample exiting the separation column after different times dependent on the strength of interaction. This time is referred to as retention time. It is a characteristic property of the respective component under the respective chromatographic conditions. The separation of compounds can be influenced by adjusting the composition of the mobile phase over time. To do this, typically 2 (or more) solvents of different types are combined using fluid actuation. Thus, a given compound elutes once the solvent composition exceeds a threshold value (e.g. a certain volumetric concentration of solvent A in a blend of solvents A and B). This threshold value is characteristic for a given compound.

Subsequently, the eluting compound can be detected by an appropriate detector located downstream of the separation column. Upon passing of the compound through the detector, a peak in the respective signal is obtained. Such a signal is referred to as a chromatogram. Depending on the complexity of the sample, the chromatogram comprises multiple peaks in short succession. For reliable discrimination and subsequent identification of a compound in a sample of complex composition (i.e., consisting of many (different) compounds), a sufficient chromatographic separation is advantageous. Therefore, typically, dedicated methods are employed to assure selectivity and sensitivity of the analysis.

Chromatography is a comparative analytical method. Thus, a given compound is identified by comparing the corresponding peaks of the detector signal against a corresponding reference. The latter is obtained by performing the analysis under conditions similar or identical with a sample of known composition. An identification of a compound of the actual sample is achieved by matching the resulting signal peak to the corresponding peak of the reference. Therefore, a high degree of reproducibility of the chromatographic process can be achieved for reliable identification in particular for complex samples. Thus, significant technological effort is being undertaken to enhance the performance of HPLC systems aiming at reproducibility.

A largely growing field of applications for HPLC systems is the pharmaceutical industry. Besides being an established technique for research and development, HPLC is widely employed in quality control (QC) in production. Therefore, there is an ever-increasing customer expectation to assure and enhance the robustness of the HPLC instrumentation. Any unplanned downtime can cause adverse effects on throughput and productivity.

Moreover, HPLC systems are increasingly used in applications where the level of training and experience of typical users is only sufficient for routine operation. However, for troubleshooting and service, the training level is frequently not sufficient. Thus, such a user base is largely relying on robust instrumentation and in the case of issues, on fast and efficient technical support. Moreover, there is a very large variety of different chromatographic separation techniques, applications and ultimately very different fluidic system configurations.

Frequently, chromatography systems are troubleshoot by means of manual probing through trained service engineer or experienced customer in a more or less systematic manner. However, this can be time consuming and can increase the downtime of the chromatography systems.

In light of the above, it is an object of the present invention to overcome or at least alleviate the shortcomings and disadvantages of the prior art. More particularly, it is an object of the present invention to provide a technology to more reliably test a fluidic system. These objects are met be the present invention.

Thus, there is a demand for a generic method for troubleshooting of arbitrary fluidic configurations. This will be addressed by the herein described approach.

In a first aspect the present invention relates to a method of testing a fluidic system. The method comprises while the fluidic system is in a first configuration applying a fluid with an input fluid characteristic to the fluidic system and measuring an output fluidic characteristic. Further, the method comprises comparing the output fluidic characteristic to a reference.

Thus, the present invention can provide a generic and efficient method of testing a fluidic system by measuring an output fluidic characteristic (while an applied fluid is flowing therein) and comparing the measurement with a reference.

The present invention can comprise multiple advantages.

As an initial matter, the present invention can allow for the detection and even the localization of errors that may be present in a fluidic system. More particularly, comparing the measured output fluidic characteristic with a reference can facilitate determining whether the fluidic system operates as expected.

Furthermore, the present invention can increase robustness and efficiency of the fluidic system. Again, by testing the fluidic system, errors can be detected (and thus, prevented or fixed). This can ensure that the fluidic system is operated efficiently and accurately.

Moreover, errors in a fluidic system (e.g. leakages, misconfigurations, blockages) may cause the fluidic system to be inoperable. Thus, errors may typically increase the downtime of the fluidic system. The present invention can alleviate this issue as it can allow for the detection and even localization of the errors. Thus, the fluidic system can be brought into an operable state faster and/or prior to the time that the fluidic system may be required to operate. In particular, the present invention may facilitate ensuring that the fluidic system is operable when required (e.g. by testing the fluidic system prior to the time when it is required for operation, e.g. between intervals that the fluidic system is scheduled to operate).

In some embodiments, the fluidic system may be used to obtain data. In such embodiments, errors in the fluidic system may cause the obtained data to be erroneous. Thus, by testing the fluidic system, the present invention may facilitate increasing the accuracy of results obtained by operating the fluidic system.

Thus, the present invention generally increases efficiency of the fluidic system. The present invention can achieve this by testing the fluidic system which can allow for the detection of errors in the fluidic system. As such, the robustness, accuracy, utilization and ease of use of the fluidic system can be increased.

Furthermore, the present invention can be advantageous as it can provide a generic method for testing the fluidic system. As discussed, the fluidic system can be tested by setting it in a first configuration and applying a fluid while it is in this configuration. It will be understood that the fluidic system may comprise a plurality of configurations. While prior art techniques typically require custom means to test each configuration of the system, respectively, the present invention can utilize the same approach to test the fluidic system irrespective of its configuration. That is, the invention may test any configuration of the fluidic system by setting the fluidic system in the respective configuration, applying a fluid with an input fluidic characteristic to the fluidic system, measuring an output fluidic characteristic while the fluidic system is in that configuration and comparing the output fluidic characteristic with a respective reference.

The present invention can be particularly advantageous for testing fluidic systems that are part of HPLC systems.

Firstly, the herein described approach can allow to compare the actual fluidic configuration of an HPLC instrumentation against an expected fluidic setup, i.e. user-defined fluidic configuration. The latter can typically represent an idealized fluidic system that would for instance be described in an application manual for a given HPLC system and configuration. In contrast, the former configuration would represent the “real-world” (i.e. actual) setup where tolerances of fluidic parts or wanted/unwanted modifications of the fluidic system can result in deviations from the ideal case.

Secondly, the present invention can provide a generic approach for mapping and probing of fluidic systems. It can thus allow for generic testing of arbitrary fluidic configurations of the fluidic system. Therefore, it can greatly alleviate the implementation of (self-) diagnostic tests of the instruments of the system. Moreover, it can greatly improve the usability of HPLC instrumentations since comprehensive means of system diagnostics can be provided. Due to the generic nature of this approach, the effort for implementing such diagnostic tests for fluidic systems in HPLC can significantly be reduced. Instead of n test implementations for n different fluidic systems or configurations, only a single implementation may be used.

Thirdly, by testing the fluidic system, the accuracy of the results obtained during the HPLC analysis can be increased. For example, a misconfiguration of the fluidic system may yield erroneous HPLC results. The present invention facilitates detecting a misconfiguration of the fluidic system and thus, reduces the likelihood of obtaining erroneous results.

In addition, in some instances the sample being analyzed in an HPLC system may be limited. As such, when analyzing the sample, it may be advantageous not to waste it. By testing the fluidic system, the present invention decreases the likelihood of wasting the sample, e.g., due to leakages.

Thus, the present invention can increase robustness and can enhance the uptime of an HPLC system. Implementation, automation and execution of tests for fluidic systems in an HPLC system can be significantly improved using the presented approach. This can facilitate system health monitoring and can thus increase robustness of HPLC instrumentation as issues can be identified and resolved faster and with little to no expert knowledge.

In addition, the present invention can provide ease of use for testing fluidic systems in an HPLC system. This can be achieved by facilitating comprehensive diagnostic tests of arbitrary fluidic configurations. Thus, little to no user expertise may be required for troubleshooting the system. The latter can be done, e.g., by automated tests based on the herein described approach. These tests can allow for the detection of deviations of the fluidic systems from a reference (e.g., ideal) specification. The deviations may be related for instance to failure of parts, incorrect system configuration (i.e. user errors), leakages and blockages.

In some embodiments, comparing the measured output fluidic characteristic to a reference can be performed by a data processing system. This can facilitate automating the testing of the fluidic system. Thus, the method of testing the fluidic system can be performed more efficiently, e.g., faster. In addition, effort required by a user of the fluidic system for testing the fluidic system can be reduced and can even not be required. This can provide incentives to perform the test as often as required or needed. That is, while otherwise high user effort to test a fluidic system may cause the user to not perform some tests, by automating the testing of the fluidic system, the likelihood of not performing the tests as/when required can be reduced. As such, the efficiency of the fluidic system can be increased.

In some embodiments, the input fluidic characteristic can be a flow rate. That is, the method can comprise applying a fluid with a predetermined or defined flow rate to the fluidic system.

In some embodiments, the input fluidic characteristic can be a pressure. That is, the method can comprise applying a fluid with a predetermined or defined pressure to the fluidic system.

In some embodiments, the output fluidic characteristic can be a flow rate. That is, measuring an output fluidic characteristic can comprise measuring a flow rate in the fluidic system.

In some embodiments, the output fluidic characteristic can be a pressure. That is, measuring an output fluidic characteristic can comprise measuring a pressure in the fluidic system.

In some embodiments, the input fluidic characteristic can be a flow rate and the output fluidic characteristic can be a pressure. That is, the fluid can be applied in the fluidic system with a defined flow rate. Based on the configuration of the fluidic system and the input flow rate, the fluid can be at a certain pressure, which can be measured. Thus, the measured pressure can be an indication of the state of the fluidic system.

In some embodiments, the input fluidic characteristic can be a pressure and the output fluidic characteristic can be a flow rate. In such embodiments, the fluid can be applied with a defined pressure. Based on the configuration of the fluidic system and the defined pressure, the fluid can flow with a certain flow rate, which can be measured. In such embodiments, the measured flow rate can be an indication of the state of the fluidic system.

Thus, the present invention can provide a simple and efficient method of testing a fluidic system as it can utilize simple techniques (e.g. setting the pressure or the flow rate) and simple measurements (e.g. measuring the flow rate or the pressure) for testing the fluidic system.

While the system is in the first configuration a first flow path can be defined therein. The first flow path can comprise a first set of fluidic components. Each fluidic component can comprise at least one component characteristic.

Each of the at least one component characteristic can respectively comprise a component fluidic resistance, at least one feature indicative for the component fluidic resistance or any combination thereof.

For example, the at least one feature indicative for the component fluid resistance can comprise at least one of, and preferably all of, a flow length, a flow cross section indication, and a temperature. Based thereon, the fluidic resistance of the fluidic component can be determined.

While the fluidic system is in the first configuration, the fluid can flow (or at least can be expected to flow) in the first flow path. The fluid flowing in the first flow path can flow through each fluidic component of the first flow path. In other words, each fluidic component of the first flow path can comprise a volume which can be occupied by the fluid flowing in the first flow path.

The reference can depend on the input fluidic characteristic. This can be advantageous as typically the flow of the fluid in the fluidic system can be affected not only by the configuration of the fluidic system, but also by the input fluidic characteristic. For example, the expected flow rate of the fluid can depend, inter alia, on the pressure in the fluidic system. As such, configuring the reference to be dependable on the input fluidic characteristic can provide more accurate testing results. In addition, considering the dependence of the reference on the input fluidic characteristic can allow for accurately testing the fluidic system with different input fluidic characteristics.

The method can comprise storing the reference in a memory device. This can facilitate the automation of the method. Moreover, storing the reference in a memory device can be particularly advantageous in embodiments wherein the comparison is performed by the data processing system, as the data processing system may automatically obtain the reference from the memory device.

In some embodiments, the method can comprise providing the reference. For example, the method can comprise providing the reference to the data processing system, e.g., the data processing system may obtain the reference from the memory device as discussed above.

In some embodiments, providing the reference can comprise determining the reference. For example, the data processing system may determine, e.g., calculate, the reference.

Determining the reference can comprise utilizing the at least one component characteristic for each fluidic component in the first set of fluidic components to determine the reference. Thus, the reference can depend on the fluidic system, more particularly on the configuration of the fluidic system, even more particularly, on the at least one component characteristic for each fluidic component comprised by the first flow path. As such, the reference can indicate an expected effect (i.e. fluidic resistance) that the fluidic components of the first flow path can have on the fluid.

In such embodiments, wherein the reference is determined, the method can comprise storing the at least one component characteristic for each fluidic component in the first set of fluidic components in a memory device.

In a preferred embodiment, the method can comprise storing the at least one component characteristic for each fluidic component of the fluidic system in a memory device. This can facilitate testing the fluidic system in each of its configurations.

Moreover, the method can comprise providing the at least one component characteristic to the data processing system. Thus, the data processing system may calculate the reference based on the obtained component characteristics.

In some embodiments, determining the reference can comprise utilizing at least one fluid characteristic corresponding to the applied fluid. This can be advantageous as the reference (e.g. the expected flow rate or the expected pressure) in the fluidic system can depend, inter alia, on the fluid applied to the fluidic system. As such, determining the reference based on at least one fluid characteristic corresponding to the applied fluid can generally yield a more accurate reference.

The at least one fluid characteristic corresponding to the applied fluid can be stored in a memory device. This can facilitate the automation of the method, particularly, when the data processing system is provided to perform the comparison.

The method can comprise providing the at least one fluid characteristic corresponding to the applied fluid to the data processing system. This can allow the data processing system to determine the reference based on the fluid characteristic.

The at least one fluid characteristic corresponding to the applied fluid can comprise a dynamic viscosity of the fluid or a feature indicative for the dynamic viscosity of the fluid.

In some embodiments, determining the reference can comprise determining a respective individual reference for each fluidic component in the first set of fluidic components and determining the reference based on the individual references. This can be particularly advantageous as it can facilitate determining the reference for each configuration of the fluidic system.

For example, the fluidic system can comprise a plurality of fluidic components. In each configuration, a fluid may flow through a subset of its components. As there can be a plurality (and typically a large number of) configurations, it may be inefficient to store a respective reference for each configuration. However, determining the reference based on the individual references of the components can be efficient as it may require less data to be stored. For example, the respective fluidic resistances of each fluidic component can be stored and based thereon the reference can be determined. Alternatively, for each component the respective individual reference can be calculated (once) and can preferably be stored for further use.

Determining the reference can comprise calculating a nominal backpressure of the first flow path. Using the backpressure of the flow path as a reference can be efficient as it can facilitate determining a plurality of results, e.g., detecting leakages, blockages or misconfigurations.

Similarly, determining a respective individual reference for each fluidic component in the first set of fluidic components can comprise calculating a respective individual nominal backpressure for each fluidic component in the first set of fluidic components. Based thereon, the total backpressure of multiple fluidic components can be calculated by summing the individual backpressures. Thus, the reference of a flow path can be determined computationally simple and fast.

In some embodiments, calculating the nominal backpressure can comprises using the Hagen-Poiseuille equation. The Hagen-Poiseuille equation can be used to calculate an ideal backpressure of cylindrical fluidic components, such as, chromatography capillaries.

In some embodiments, calculating the nominal backpressure can comprises using the Kozeny-Carman equation. This can be particularly advantageous for calculating the backpressure of packed fluidic components, such as, chromatography columns.

In some embodiments, the method can comprise utilizing a fluidic actuator to apply a fluid with an input fluidic characteristic to the fluidic system. More particularly, the method can comprise configuring at least one fluidic actuator to provide the fluid with the input fluidic characteristic.

For example, the fluid actuator can be a pump. The pump can be configured to provide a fluid with a constant flow or with a constant pressure to the fluidic system. Thus, the pump can facilitate applying a fluid with an input fluidic characteristic (e.g. a defined flow rate or a defined pressure).

As discussed, in some embodiments, while the fluidic system is in a first configuration a first flow path can be defined therein. In such embodiments, applying a fluid with an input fluidic characteristic to the fluidic system, while the fluidic system is in a first configuration, can comprise applying the fluid with an input fluidic characteristic to the first flow path. As such, the applied fluid can flow through the first flow path. This can allow the first flow path of the fluidic system to be tested.

Moreover, the fluidic actuator and the data processing system can be configured such that the data processing system may control the fluidic actuator. In such embodiments, the method can comprise the data processing system controlling the at least one fluidic actuator. For example, the data processing system may switch the fluidic actuator on or off, may control or define the activation cycles of the fluidic actuator and may configure the fluidic actuator to provide the fluid with the input fluidic characteristic, e.g., with a defined pressure or with a defined flow rate. For example, the data processing system may obtain one or more fluidic actuator control parameters (e.g., activation cycles or intervals and the input fluidic characteristic, e.g., pressure or flow rate) and based thereon it may control the fluidic actuator. The fluidic actuator control parameters can be stored in a memory device that can be accessed by the data processing system, e.g., the memory device wherein the reference is stored. This can further increase the automation of the method.

It will be understood that in a similar manner each flow path that can be defined in the fluidic system can be tested. That is, the fluidic system can be set in any operable configuration, wherein one or more respective flow paths can be defined therein. A fluid with an input characteristic can be applied to each of the flow paths, thus, allowing for each flow path to be tested.

Measuring an output fluidic characteristic can comprise measuring the output fluidic characteristic with at least one sensor device configured to measure the output fluidic characteristic, a feature indicative of the output fluidic characteristic or any combination thereof. That is, the output fluidic characteristic can be measured directly or indirectly. In general, any technique that can facilitate obtaining the output fluidic characteristic and/or indicate the output fluidic characteristic can be used.

The at least one sensor device that can be used to measure the output fluidic characteristic can be a pressure sensor. This can be particularly advantageous when the output fluidic characteristic is a pressure, as the pressure sensor can directly measure the pressure.

The at least one sensor device that can be used to measure the output fluidic characteristic can be a flow rate sensor. This can be particularly advantageous when the output fluidic characteristic is a flow rate, as the flow rate sensor can directly measure the flow rate.

Measuring an output fluidic characteristic can comprise determining a backpressure. For example, one or more measurements can be performed and based thereon the backpressure can be calculated. Thus, an actual backpressure can be determined.

Measuring an output fluidic characteristic can comprise measuring an output fluidic characteristic corresponding to the first flow path.

In some embodiments, wherein a plurality of flow paths can be defined in the fluidic system, the output fluidic characteristic can be measured at a portion of the fluidic system that can be common to all or to a plurality of flow paths. For example, the fluidic system can comprise an inlet (e.g., wherein the fluidic actuator is fluidly connected to the fluidic system), which inlet can be a starting point of each or of a plurality of flow paths. The output fluidic characteristic can be measured at the inlet (e.g. at the output of the fluidic actuator). This can be advantageous as it can allow the method to test each or a plurality of flow paths that can be defined in the fluidic system, with a single implementation. Additionally, this can reduce the number of sensor devices that may be required, as the same sensor device can be used to measure the output fluidic characteristic for a plurality of flow paths.

Moreover, it can be particularly advantageous to measure the output fluidic characteristic at the inlet of the fluidic system (e.g. directly at the output of the fluidic actuator or the start of a flow path) as this can provide a more accurate measurement corresponding to the flow path. For example, the backpressure of the entire flow path can be determined more accurately if the output fluidic characteristic is measured at the start of the flow path.

The method can comprise providing the output fluidic characteristic to the data processing system. For example, the data processing system may automatically obtain the output fluidic characteristic from the at least one sensor device that is used to measure the output fluidic characteristic.

Comparing the measured output fluidic characteristic to a reference can comprise calculating a distance metric between the measured output fluidic characteristic and the reference.

Moreover, comparing the measured output fluidic characteristic to a reference can comprise defining a lower threshold margin and/or an upper threshold margin.

In such embodiments, comparing the measured output fluidic characteristic to a reference can comprise comparing the distance metric to the lower threshold margin and/or to the upper threshold margin.

Using the threshold margins can be advantageous as it can facilitate identifying significant discrepancies and/or neglecting negligible discrepancies (which may be, e.g., due to measurement errors). Thus, the false positive rate of the test can be reduced.

Moreover, using a lower threshold margin and upper threshold margin can be advantageous as it can increase the amount of information that can be determined based on the comparison. For example, using the lower threshold margin and the upper threshold margin can facilitate determining whether there is a leakage in the fluidic system and whether there is a blockage in the fluidic system.

The method can further comprise determining a result based on the comparison. Thus, the state of the fluidic system can be determined. That is, based on the comparison the fluidic system can be evaluated.

Determining a result can comprise detecting a difference between the first configuration and an expected configuration.

Determining a result can comprise locating a difference between the first configuration and an expected configuration.

That is, the present method can detect and locate an error in a fluidic system. This may typically include applying the fluid in different flow paths of the fluidic system and based on the obtained results for each flow path, the error may be located.

Determining a result can comprise at least one of detecting a blockage in the fluidic system, detecting a leakage in the fluidic system, detecting a misconfiguration of the fluidic system, detecting the use of a wrong fluidic component, such as, the use of a wrong conduit and detecting the use of a wrong fluid, such as, the use of an incorrect solvent (e.g., acetonitrile instead of water, which comprise different viscosity and thus are subject to different fluidic resistances).

In other words, determining a result can comprise detecting an error in the fluidic system. In some embodiments, determining a result can comprise locating the error in the fluidic system. For example, when an error is detected the method can comprise locating the error. The error can be a blockage in the fluidic system, a leakage in the fluidic system, a misconfiguration of the fluidic system, a use of a wrong fluidic component, such as, the use of a wrong conduit, a use of a wrong fluid, such as, use of incorrect solvent or any combination thereof.

The method can comprise setting the fluidic system in the first configuration. For example, prior to applying the fluid with an input fluidic characteristic, the fluidic system can be set in the first configuration.

In some embodiments, the data processing system can facilitate setting the fluidic system in the first configuration.

The fluidic system can comprise at least one fluidic switch and wherein setting the fluidic system in the first configuration can comprise controlling the at least one fluidic switch. An example of a fluidic switch that can be comprised by the fluidic system is described, for example, in U.S. Pat. No. 8,806,922 B2, referred therein as an injection valve.

Moreover, the data processing system can control the at least one fluidic switch.

The method can further comprise while the fluidic system is in a second configuration, which is different to the first configuration, applying a fluid with a second input fluidic characteristic to the fluidic system and measuring a second output fluidic characteristic and comparing the measured second output fluidic characteristic to a second reference.

That is, the fluidic system can assume more than one configurations and the method can be configured to test the system in any of the configurations. Thus, different flow paths that can be defined in the fluidic system can be tested.

A second flow path can be defined in the second fluidic configuration. The second flow path can comprise a second set of fluidic components, wherein each fluidic component comprises at least one component characteristic, respectively.

In some embodiments, the first set of fluidic components can comprise one fluidic component in addition to the second set of fluidic components. That is, the first and the second configurations can be determined such that the first set of fluidic components can comprise one fluidic component in addition to the second set of fluidic components.

In such embodiments, the method can comprise determining a result corresponding to the additional fluidic component. For example, the results obtained while the fluidic system is in the first configuration can be compared with the results obtained while the fluidic system is in the second configuration.

It will be understood that in a similar manner more than two flow paths can be tested to determine a result for a particular fluidic component of the fluidic system

Locating the error in the fluidic system can comprise utilizing the comparison of the measured output fluidic characteristic to the reference and the comparison of the second measured output fluidic characteristic to the second reference.

The method can be a computer-implemented method. This can allow the fluidic system to be tested automatically, e.g., by the data processing system.

In some embodiments, the method can comprise providing a testing schedule to the data processing system and the data processing system testing the fluidic system according to the testing schedule. The testing schedule may, for example, specify a time for carrying out the test, a configuration for setting the fluidic system in and an input fluidic characteristic.

In a second aspects the present invention relates to a fluidic system for controlling the flow of a fluid. The fluidic system can be configured to be operable in at least one configuration.

The fluidic system can comprise a plurality of fluidic components, each comprising a respective volume that can be occupied by a fluid flowing in the fluidic system.

Each fluidic component can comprise at least one component characteristic, respectively.

Each of the at least one component characteristic can respectively comprise a component fluidic resistance, at least one feature indicative for the component fluidic resistance or any combination thereof.

For example, the fluidic components can be actuators (e.g. pumps), conduits (e.g. capillaries), fluidic switches, valves, chromatography columns, mixers, detector flow cells, needles, needle receiving elements, connectors, ports and autosamplers. In general, the fluidic system can comprise any device that can be used in a chromatography system, such as, in a liquid chromatography system, for example, high-performance liquid chromatography or ultra-high-performance liquid chromatography.

The fluidic system can comprise at least one input fluidic component.

The input fluidic component can be configured to provide a fluid with a defined flow rate and/or pressure.

The at least one input fluidic component can be a fluidic actuator, such as, a pump.

The fluidic system can comprise at least output fluidic component.

The at least one output fluidic component can be substantially at ambient pressure, e.g., a difference of the pressure of the at least one output fluidic component and ambient pressure may be smaller than 50 bar, preferably smaller than 5 bar, such as smaller than 0.1 bar.

The fluidic system can comprise at least one conduit.

The fluidic system can comprise at least one fluidic switch.

Each of the at least one fluidic switch can be configured to facilitate setting the fluidic system in at least one configuration.

Each of the at least one fluidic switch can be configured to allow a fluid to flow in a selected set of fluidic components and to disallow the flow in at least one other fluidic component.

Each of the at least one fluidic switch can comprise a plurality of ports and each of the ports can be configured to facilitate a fluid to be introduced into the fluidic switch and to be output from the fluidic switch.

Each of the at least one fluidic switch can comprise a plurality of states, respectively, and in each state of a fluidic switch a fluidic connection can be rendered between at least two ports of the fluidic switch, allowing a fluid to flow between the connected ports. Alternatively or additionally, in each state, a fluidic isolation can be rendered between at least two ports of the fluidic switch, preventing a fluid from flowing between the isolated ports. Alternatively or additionally, in each state, a fluidic isolation of at least one port of the fluidic switch can be rendered, preventing a fluid from flowing between the isolated port and the other ports of the fluidic switch.

The fluidic system can be configured such that in each of the at least one configurations of the fluidic system, a respective flow path can be defined.

Each flow path may consist of a set of fluidic components, which set can be a subset of all the fluidic components comprised by the fluidic system.

The fluidic system can comprise at least one sensor device.

The at least one sensor device can be configured to measure at least one of a pressure and a flow rate of a fluid flowing in the fluidic system.

In some embodiments, the at least one sensor device can be configured to measure a feature indicative for the pressure and/or flow rate of a fluid flowing in the fluidic system. That is, the sensor device can be configured to perform an indirect measurement of the pressure and/or flow rate of a fluid flowing in the fluidic system.

The at least one sensor device can be configured to perform a measurement for facilitating the determination of the backpressure of the fluidic system.

The backpressure of the fluidic system can correspond to the backpressure of the flow path defined in the fluidic system.

The fluidic system can be part of a chromatography system. In such embodiments, the fluidic system can be configured to propel and guide fluids of the chromatography system.

The fluidic system can comprise at least one automatic control function, which can facilitate setting the fluidic system in one of the at least one configurations.

The method, described above, can be used to test the fluidic system described with respect to the second aspect of the present invention. That is, the fluidic system tested by the method can comprise any of the above-discussed features with respect to the second aspect of the present invention.

In a third aspect, the present invention relates to a testing system configured for testing a fluidic system. The testing system comprises at least one sensor device configured to facilitate measuring an output fluidic characteristic. In addition, the testing system comprises a data processing system configured to obtain the output fluidic characteristic and a reference and to compare the output fluidic characteristic with the reference.

The testing system and the method (discussed above) can comprise equivalent features and equivalent advantages. For the sake of brevity, some of the equivalent features and advantages discussed with respect to the method can be omitted in the following description of the testing system.

The fluidic system that can be tested by the testing system can comprise any of the features of the fluidic system discussed above with reference to the second aspect of the present invention.

The at least one sensor device can be integrated into the fluidic system.

The testing system can further comprise a memory device.

The memory device can be configured to store, inter alia, the reference.

In some embodiments, the memory device can be configured to store a data system.

The data system can be configured to store the at least one component characteristic of each fluidic component. That is, the data system can comprise descriptive (i.e., specification, e.g., data sheet) data for each fluidic component. This can facilitate determining the reference.

The data system can comprise computer instructions for controlling the fluidic system. This can facilitate setting the fluidic system in a respective configuration.

The data system can be a chromatography data system. An example of a chromatography data system is the Thermo Scientific™ Chromeleon™ Chromatography Data System (CDS) software.

The data processing system can be configured to access the memory device.

The data processing system can be configured to obtain the reference by obtaining at least one component characteristics and/or fluid characteristics from the memory device and then utilizing those to calculate the reference. That is, the memory device can be configured to store the at least at least one component characteristics and fluid characteristics.

The data processing system can be configured to execute the computer instructions of the data system. Thus, the data processing system can be configured to set the fluidic system in a respective configuration.

The data processing system can be configured to trigger the at least one sensor device to perform a measurement.

The data processing system can be configured to obtain the output fluidic characteristic by obtaining sensor data output by the at least one sensor device after performing the measurement and based thereon determining the output fluidic characteristic.

The data processing system can be configured to generate a result based on the comparison.

The fluidic system can comprise an input fluidic component and the data processing system can be configured to control the input fluidic component.

More particularly the data processing system can be configured to control the input fluidic component to apply a fluid with an input fluidic characteristic to the fluidic system.

The testing system can be configured to carry out the method of testing a fluidic system, discussed above.

Overall, the present technology may be different to other means to automatically test fluidic networks, where the tests are limited to a given fluidic configuration only. The workflow of such tests (limited to one configuration) is typically hardcoded in software (SW) or firmware of the chromatography control system and for a given fluidic configuration. Thus, if the fluidic configuration is altered and thus, deviates from the expected “standard” configuration, the test is no longer applicable in such approaches limited to one configuration. Since in the field of chromatography a large variety of different fluidic configurations is employed, the test coverage by such automated limited tests is rather low. Either no test exists for fluidic configurations or only a small subset of a fluidic network can be tested automatically. This may be different by embodiments of the present technology, allowing an increased versatility and usability.

In still other words, embodiments of the present technology provide a generic approach that allows for analyzing of arbitrary fluidic networks.

The present technology is also defined by the following numbered embodiments.

Below, method embodiments will be discussed. These embodiments are abbreviated by the letter “M” followed by a number. When reference is herein made to method embodiments, these embodiments are meant.

M1. A method of testing a fluidic system, the method comprising while the fluidic system is in a first configuration, applying a fluid with an input fluidic characteristic to the fluidic system and measuring an output fluidic characteristic; and comparing the measured output fluidic characteristic to a reference.

M2. The method according to the preceding embodiment, wherein comparing the measured output fluidic characteristic to a reference is performed by a data processing system.

M3. The method according to any of the preceding embodiments, wherein the input fluidic characteristic is a flow rate.

M4. The method according to any of the preceding embodiments, wherein the input fluidic characteristic is a pressure.

M5. The method according to any of the preceding embodiments, wherein the output fluidic characteristic is a flow rate.

M6. The method according to any of the preceding embodiments, wherein the output fluidic characteristic is a pressure.

M7. The method according to any of the preceding embodiments, wherein the input fluidic characteristic is a flow rate and the output fluidic characteristic is a pressure.

M8. The method according to any of the preceding embodiments, wherein the input fluidic characteristic is a pressure and the output fluidic characteristic is a flow rate.

M9. The method according to any of the preceding embodiments, wherein a first flow path is defined in the first fluidic configuration, the first flow path comprising a first set of fluidic components, wherein each fluidic component comprises at least one component characteristic, respectively.

M10. The method according to the preceding embodiment, wherein each of the at least one component characteristic respectively comprises a component fluidic resistance, at least one feature indicative for the component fluidic resistance or any combination thereof.

M11. The method according to the preceding embodiment, wherein the at least one feature indicative for the component fluid resistance comprises at least one of, and preferably all of, a flow length, a flow cross section indication, and a temperature.

M12. The method according to any of the preceding embodiments, wherein the reference depends on the input fluidic characteristic.

M13. The method according to any of the preceding embodiments, wherein the method comprises storing the reference in a memory device.

M14. The method according to any of the preceding embodiments, wherein the method comprises providing the reference.

M15. The method according to the preceding embodiment and with the features of embodiment M2, wherein providing the reference comprises providing the reference to the data processing system.

M16. The method according to embodiment M14, wherein providing the reference comprises determining the reference.

M17. The method according to the preceding embodiment and with the features of embodiment M2, wherein the data processing system determines the reference.

M18. The method according to any of the 2 preceding embodiments and with the features of embodiment M9, wherein determining the reference comprises utilizing the at least one component characteristic for each fluidic component in the first set of fluidic components to determine the reference.

M19. The method according to the preceding embodiment, wherein the method comprises storing the at least one component characteristic for each fluidic component in the first set of fluidic components in a memory device.

M20. The method according to any of the 2 preceding embodiments and with the features of embodiment M17, wherein the method comprises providing the at least one component characteristic for each fluidic component in the first set of fluidic components to the data processing system.

M21. The method according to any of the preceding embodiments and with the features of embodiment M16, wherein determining the reference comprises utilizing at least one fluid characteristic corresponding to the applied fluid.

M22. The method according to the preceding embodiment, wherein the method comprises storing the at least one fluid characteristic corresponding to the applied fluid in a memory device.

M23. The method according to any of the 2 preceding embodiments and with the features of embodiment M17, wherein the method comprises providing the at least one fluid characteristic corresponding to the applied fluid to the data processing system.

M24. The method according to any of the 3 preceding embodiments, wherein the at least one fluid characteristic corresponding to the applied fluid comprises a dynamic viscosity of the fluid or a feature indicative for the dynamic viscosity of the fluid.

M25. The method according to any of the preceding embodiments and with the features of embodiments M9 and M16, wherein determining the reference comprises

determining a respective individual reference for each fluidic component in the first set of fluidic components and

determining the reference based on the individual references.

M26. The method according to any of the preceding embodiments and with the features of embodiments M9 and M16, wherein determining the reference comprises calculating a nominal backpressure of the first flow path.

M27. The method according to any of the 2 preceding embodiments, wherein determining a respective individual reference for each fluidic component in the first set of fluidic components comprises

calculating a respective individual nominal backpressure for each fluidic component in the first set of fluidic components.

M28. The method according to any of the 2 preceding embodiments, wherein calculating the nominal backpressure comprises using the Hagen-Poiseuille equation.

M29. The method according to any of the 3 preceding embodiments, wherein calculating the nominal backpressure comprises using the Kozeny-Carman equation.

M30. The method according to any of the preceding embodiments, wherein applying a fluid with an input fluidic characteristic to the fluidic system comprises configuring at least one fluidic actuator to provide the fluid with the input fluidic characteristic.

M31. The method according to the preceding embodiment, wherein the fluidic actuator is a pump.

M32. The method according to any of the preceding embodiments and with the features of embodiment M9, wherein while the fluidic system is in the first configuration, applying a fluid with an input fluidic characteristic to the fluidic system comprises

applying a fluid with an input fluidic characteristic to the first flow path.

M33. The method according to any of the 3 preceding embodiments and with the features of embodiment M2, wherein the method comprises the data processing system controlling the at least one fluidic actuator.

M34. The method according to any of the preceding embodiments, wherein measuring an output fluidic characteristic comprises measuring the output fluidic characteristic with at least one sensor device configured to measure the output fluidic characteristic, a feature indicative of the output fluidic characteristic or any combination thereof.

M35. The method according to the preceding embodiments, wherein the at least one sensor device comprises a pressure sensor.

M36. The method according to any of the 2 preceding embodiments, wherein the at least one sensor device is a flow rate sensor.

M37. The method according to any of the preceding embodiments, wherein measuring an output fluidic characteristic comprises determining a backpressure.

M38. The method according to any of the preceding embodiments and with the features of embodiment M9, wherein measuring an output fluidic characteristic comprises

measuring an output fluidic characteristic corresponding to the first flow path.

M39. The method according to any of the preceding embodiments and with the features of embodiment M2, wherein the method comprises providing the output fluidic characteristic to the data processing system.

M40. The method according to any of the preceding embodiments, wherein comparing the measured output fluidic characteristic to a reference comprises

calculating a distance metric between the measured output fluidic characteristic and the reference.

M41. The method according to any of the preceding embodiment, wherein comparing the measured output fluidic characteristic to a reference comprises

defining a lower threshold margin and/or an upper threshold margin.

M42. The method according to the two preceding embodiment, wherein comparing the measured output fluidic characteristic to a reference comprises

comparing the distance metric to the lower threshold margin and/or to the upper threshold margin.

M43. The method according to any of the preceding embodiments, wherein the method further comprises determining a result based on the comparison.

M44. The method according to the preceding embodiment, wherein determining a result comprises

detecting a difference between the first configuration and an expected configuration.

M45. The method according to any of the 2 preceding embodiments, wherein determining a result comprises

locating a difference between the first configuration and an expected configuration.

M46. The method according to any of the 3 preceding embodiments, wherein determining a result comprises at least one of

detecting a blockage in the fluidic system,

detecting a leakage in the fluidic system,

detecting a misconfiguration of the fluidic system,

detecting the use of a wrong fluidic component, such as, the use of a wrong conduit, and

detecting the use of a wrong fluid, such as, the use of incorrect solvent.

M47. The method according to any of the 4 preceding embodiments, wherein determining a result comprises locating an error in the fluidic system.

M48. The method according to the preceding embodiment, wherein the error comprises at least one of

a blockage in the fluidic system,

a leakage in the fluidic system,

a misconfiguration of the fluidic system,

a use of a wrong fluidic component, such as, the use of a wrong conduit, and

a use of a wrong fluid, such as, use of incorrect solvent.

M49. The method according to any of the preceding embodiments, wherein the method comprises setting the fluidic system in the first configuration.

M50. The method according to the preceding embodiment and with the features of embodiment M2, wherein the data processing system facilitates setting the fluidic system in the first configuration.

M51. The method according to any of the 2 preceding embodiments, wherein the fluidic system comprises at least one fluidic switch and

wherein setting the fluidic system in the first configuration comprises controlling the at least one fluidic switch.

M52. The method according to the preceding embodiment and with the features of embodiment M2, wherein the data processing system controls the at least one fluidic switch.

M53. The method according to any of the preceding embodiments, wherein the method comprises

while the fluidic system is in a second configuration, which is different to the first configuration, applying a fluid with a second input fluidic characteristic to the fluidic system and measuring a second output fluidic characteristic; and

comparing the measured second output fluidic characteristic to a second reference.

That is, the fluidic system can assume more than one configurations and the method can be configured to test the system in any of the configurations.

M54. The method according to the preceding embodiment, wherein a second flow path is defined in the second fluidic configuration, the second flow path comprising a second set of fluidic components, wherein each fluidic component comprises at least one component characteristic, respectively.

M55. The method according to the preceding embodiment and with the features of embodiment M9, wherein the first set of fluidic components comprises one fluidic component in addition to the second set of fluidic components.

M56. The method according to the preceding embodiment, wherein the method comprises determining a result corresponding to the additional fluidic component.

M57. The method according to any of the preceding embodiments with the features of embodiments M47 and M53, wherein locating the error in the fluidic system comprises utilizing the comparison of the measured output fluidic characteristic to the reference and the comparison of the second measured output fluidic characteristic to the second reference.

M58. The method according to any of the preceding embodiments, wherein the method is a computer-implemented method.

M59. The method according to any of the preceding embodiments, wherein the method comprises providing a testing schedule to the data processing system.

M60. The method according to the preceding embodiments, wherein the method comprises

the data processing system carrying out the method according to the testing schedule.

M61. The method according to any of the 2 preceding embodiments, wherein the method comprises

testing the fluidic system according to the testing schedule.

M62. The method according to any of the 3 preceding embodiments, wherein the testing schedule specifies at least one of

a time for carrying out the test,

a configuration for setting the fluidic system in and

an input fluidic characteristic with which to apply the fluid to the fluidic system while the fluidic system is in the configuration specified in the testing schedule.

M63. The method according to the preceding embodiments, wherein the time specified in the testing schedule excludes the times during which the fluidic system is expected to be utilized.

Below, fluidic system embodiments will be discussed. These embodiments are abbreviated by the letter “F” followed by a number. When reference is herein made to fluidic system embodiments, these embodiments are meant.

F1. A fluidic system (10) for controlling the flow of a fluid configured to be operable in at least one configuration.

F2. The fluidic system (10) according to the preceding embodiment, wherein the fluidic system (10) comprises a plurality of fluidic components, each comprising a respective volume that can be occupied by a fluid flowing in the fluidic system (10).

F3. The fluidic system (10) according to the preceding embodiment, wherein each fluidic component comprises at least one component characteristic, respectively.

F4. The fluidic system (10) according to the preceding embodiment, wherein each of the at least one component characteristic respectively comprises a component fluidic resistance, at least one feature indicative for the component fluidic resistance or any combination thereof.

For example, the fluidic components can be actuators (e.g. pumps), conduits (e.g. capillaries), fluidic switches, valves, chromatography columns, mixers, detector flow cells, needles, needle receiving elements, connectors, ports and autosamplers. In general, the fluidic system can comprise any device that can be used in a chromatography system, such as, in a liquid chromatography system, for example, high-performance liquid chromatography or ultra-high-performance liquid chromatography.

F5. The fluidic system (10) according to any of the fluidic system embodiments, comprising at least one input fluidic component (1).

F6. The fluidic system (10) according to the preceding embodiment, wherein the input fluidic component (1) is configured to provide a fluid with a defined flow rate and/or pressure.

F7. The fluidic system (10) according to any of the 2 preceding embodiments, wherein the at least one input fluidic component (10) is a fluidic actuator (1), such as, a pump.

F8. The fluidic system (10) according to any of the fluidic system embodiments, comprising at least output fluidic component (7).

F9. The fluidic system (10) according to the preceding embodiment, wherein the at least one output fluidic component (7) is substantially at ambient pressure, e.g., wherein a difference of the pressure of the at least one output fluidic component (7) and ambient pressure is smaller than 50 bar, preferably smaller than 5 bar, such as smaller than 0.1 bar.

F10. The fluidic system (10) according to any of the fluidic system embodiments, wherein the fluidic system (10) comprises at least one conduit.

F11. The fluidic system (10) according to any of the fluidic system embodiments, comprising at least one fluidic switch (2).

F12. The fluidic system (10) according to the preceding embodiment, wherein each of the at least one fluidic switch (2) is configured to facilitate setting the fluidic system (10) in at least one configuration.

F13. The fluidic system (10) according to any of the 2 preceding embodiments and with the features of embodiment F2, wherein each of the at least one fluidic switch (2) is configured to allow a fluid to flow in a selected set of fluidic components and to disallow the flow in at least one other fluidic component.

F14. The fluidic system (10) according to any of the 3 preceding embodiments, wherein each of the at least one fluidic switch (2) comprises a plurality of ports and wherein each of the ports is configured to facilitate a fluid to be introduced into the fluidic switch (2) and to be output from the fluidic switch (2).

F15. The fluidic system (10) according to the preceding embodiment, wherein each of the at least one fluidic switch (2) comprises a plurality of states, respectively, and wherein in each state of a fluidic switch (2)

a fluidic connection is rendered between at least two ports of the fluidic switch (2), allowing a fluid to flow between the connected ports,

a fluidic isolation is rendered between at least two ports of the fluidic switch (2), preventing a fluid from flowing between the isolated ports,

a fluidic isolation of at least one port of the fluidic switch (2) is rendered, preventing a fluid from flowing between the isolated port and the other ports of the fluidic switch (2),

or any combination thereof.

F16. The fluidic system (10) according to any of the fluidic system embodiments, wherein the fluidic system is configured such that in each of the at least one configurations of the fluidic system (10), a respective flow path (12) is defined.

F17. The fluidic system (10) according to the preceding embodiment and with the features of embodiment F2, wherein each flow path (12) consists of a set of fluidic components, which set can be a subset of all the fluidic components comprised by the fluidic system (10).

F18. The fluidic system (10) according to any of the fluidic system embodiments, comprising at least one sensor device (13).

F19. The fluidic system (10) according to the preceding embodiment, wherein the at least one sensor device (13) is configured to measure a pressure and/or flow rate of a fluid flowing in the fluidic system (10).

F20. The fluidic system (10) according to any of the 2 preceding embodiments, wherein the at least one sensor device (13) is configured to measure a feature indicative for the pressure and/or flow rate of a fluid flowing in the fluidic system (10).

F21. The fluidic system (10) according to any of the 3 preceding embodiments, wherein the at least one sensor device (13) is configured to perform a measurement for facilitating the determination of the backpressure of the fluidic system (10).

F22. The fluidic system (10) according to the preceding embodiment and embodiment F16,

wherein the backpressure of the fluidic system (10) corresponds to the backpressure of the flow path (12) defined in the fluidic system (10).

F23. The fluidic system (10) according to any of the fluidic system embodiments, wherein the fluidic system (10) is part of a chromatography system and wherein the fluidic system (10) is configured to propel and guide fluids of the chromatography system.

F24. The fluidic system (10) according to any of the fluidic system embodiments, wherein the fluidic system (10) comprises at least one automatic control function, which facilitates setting the fluidic system (10) in one of the at least one configurations.

Below further method embodiments will be discussed.

M64. The method according to any of the preceding method embodiments, wherein the fluidic system is according to any of the preceding fluidic system embodiments.

Below, testing system embodiments will be discussed. These embodiments are abbreviated by the letter “T” followed by a number. When reference is herein made to testing system embodiments, these embodiments are meant.

T1. A testing system (30) configured for testing a fluidic system (10), the testing system comprising

at least one sensor device (13) configured to facilitate measuring an output fluidic characteristic (15);

a data processing system (40) configured to obtain the output fluidic characteristic (15) and a reference (25) and to compare the output fluidic characteristic (15) with the reference (25).

T2. The testing system (30) according to the preceding embodiment, wherein the fluidic system (10) is configured according to any of the preceding fluidic system embodiments.

T3. The testing system (30) according to any of the preceding testing system embodiments, wherein the at least one sensor device (13) is integrated into the fluidic system (10).

T4. The testing system (30) according to any of the preceding testing system embodiments, wherein the at least one sensor device (13) is configured to measure a pressure and/or flow rate of a fluid flowing in the fluidic system (10).

T5. The testing system (30) according to any of the preceding testing system embodiments, wherein the at least one sensor device (13) is configured to measure a feature indicative for the pressure and/or flow rate of a fluid flowing in the fluidic system (10).

T6. The testing system (30) according to any of the preceding testing system embodiments, wherein the at least one sensor device (13) is configured to perform a measurement for facilitating the determination of the backpressure of the fluidic system (10).

T7. The testing system (30) according to the preceding embodiment and wherein the fluidic system (10) comprises the features of embodiment F14,

wherein the backpressure of the fluidic system (10) corresponds to the backpressure of the flow path (12) defined in the fluidic system (10).

T8. The testing system (30) according to any of the preceding testing system embodiments, wherein the testing system (30) further comprises a memory device (20).

T9. The testing system (30) according to the preceding embodiment, wherein the memory device (20) is configured to store a data system (23).

T10. The testing system (30) according to the preceding embodiment and wherein the fluidic system (10) comprises the features of embodiment F3, wherein the data system is configured to store the at least one component characteristic of each fluidic component.

T11. The testing system (30) according to any of the 2 preceding embodiments, wherein the data system (23) comprises computer instructions for controlling the fluidic system (10).

T12. The testing system (30) according to any of the 2 preceding embodiments, wherein the data system (23) is a chromatography data system.

T13. The testing system (30) according to any of the preceding testing system embodiments and with the features of embodiment T8, wherein the data processing system (40) is configured to access the memory device (20).

T14. The testing system (30) according to any of the preceding testing system embodiments and with the features of embodiment T10, wherein the data processing system (40) is configured to obtain the reference (25) by obtaining at least one component characteristics and/or fluid characteristics from the memory device (20) and then utilizing those to calculate the reference (25).

T15. The testing system (30) according to any of the preceding testing system embodiments and with the features of embodiment T11, wherein the data processing system (40) is configured to execute the computer instructions of the data system (23).

T16. The testing system (30) according to any of the preceding testing system embodiments, wherein the data processing system (40) is configured to trigger the at least one sensor device (13) to perform a measurement.

T17. The testing system (30) according to any of the preceding testing system embodiments, wherein the data processing system (40) is configured to obtain the output fluidic characteristic (15) by obtaining sensor data outputted by the at least one sensor device (13) after performing the measurement and based thereon determining the output fluidic characteristic (15).

T18. The testing system (30) according to any of the preceding testing system embodiments, wherein the data processing system (40) is configured to generate a result (45) based on the comparison.

T20. The testing system (30) according to any of the preceding testing system embodiments, wherein the fluidic system (10) comprises an input fluidic component (1) and the data processing system (40) is configured to control the input fluidic component (1).

T21. The testing system (30) according to the preceding embodiments, wherein the data processing system (40) is configured to control the input fluidic component (1) to apply a fluid with an input fluidic characteristic to the fluidic system.

T22. The testing system (30) according to any of the preceding testing system embodiments, wherein the testing system (30) is configured to carry out the method according to any of the preceding method embodiments.

T23. The testing system (30) according to any of the testing system embodiments, wherein the testing system (30) comprises the fluidic system.

### BRIEF DESCRIPTION OF THE DRAWINGS

FIG. 1 illustrates a fluidic system;

FIGS. 2 and 3 illustrate a method for testing a fluidic system;

FIG. 4 illustrates a testing system for testing a fluidic system.

### DETAILED DESCRIPTION OF THE DRAWINGS

In the following, exemplary embodiments of the invention will be described, referring to the figures. These examples are provided to give further understanding of the invention, without limiting its scope.

In the following description, a series of features and/or steps are described. The skilled person will appreciate that unless explicitly required and/or unless required by the context, the order of features and steps is not critical for the resulting configuration and its effect. Further, it will be apparent to the skilled person that irrespective of the order of features and steps, the presence or absence of time delay between steps can be present between some or all of the described steps.

It is noted that not all the drawings carry all the reference signs. Instead, in some of the drawings, some of the reference signs have been omitted for sake of brevity and simplicity of illustration. Embodiments of the present invention will now be described with reference to the accompanying drawings.

Embodiments of the present invention provide a generic approach to characterize or test a given fluidic network (such as an HPLC system). The presented approach can be assisted by or can utilize a fluidic description framework. This approach can allow for identification and relocation of issues of fluidic networks such as blockages, leakages or misconfiguration (i.e. user errors).

Some principles of the presented approach may be similar to probing of electric circuits. Here, a fluidic path is subjected to a certain flow (or pressure) by a pump. Analogously to the electrical probing, the fluidic resistivity, i.e. the backpressure of the given flow path (subset of the fluidic system) is determined. The actual (measured) backpressure of this fluidic path can be compared with an expected (calculated) backpressure value. Thus, a significant discrepancy between the actual and expected backpressure would be indicative of an issue related to this fluidic path.

With reference to the figures, some embodiments of the present invention will be discussed in more detail.

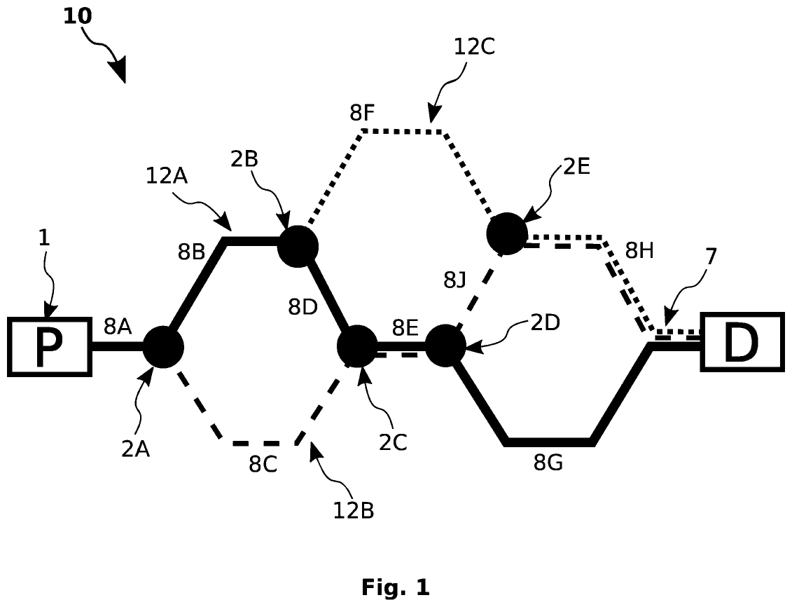

FIG. 1 illustrates a fluidic system 10, which can also be referred to as a fluidic network 10. The fluidic system 10 can be part of chromatography system. The fluidic system 10 can be configured for propelling and guiding a fluid in a controlled manner. Thus, a fluid can be transmitted from a start location to an end location through the fluidic system 10. For example, in a chromatography system, the fluidic system 10 can allow the transmittal of fluids between different devices of the chromatography system. For example, a sample can be transmitted from a sample vial to a chromatography column through the fluidic system 10.

The fluidic system 10 can comprise a plurality of fluidic components, which can also be referred to as fluidic elements. A fluidic component can be any component comprising a volume that can be occupied by a fluid flowing in the fluidic system 10. For example, the fluidic elements can be actuators (e.g. pumps), conduits (e.g. capillaries), fluidic switches, valves, chromatography columns, mixers, detector flow cells, needles, needle receiving elements, connectors, ports and autosamplers. It will be understood that the above list is not an exhaustive list of all the fluidic elements that can be comprised by a fluidic system 10.

The fluidic system 10 can be rendered into one or more configurations. That is, the fluidic system may assume different configuration. In each configuration of the fluidic system 10, a respective flow path 12 can be defined. That is, in each configuration, the fluidic system 10 can guide a fluid according to a respective flow path 12. FIG. 1 illustrates three exemplary flow paths 12A, 12B and 12C. Each of the flow paths 12A, 12B and 12C relates to a respective configuration of the fluidic system 10 and can guide the fluid in a different way. Moreover, each of the flow paths 12A, 12B and 12C can be created (i.e. defined) by bringing the fluidic system 10 into a respective configuration.

A flow path 12 can consist of a set of fluidic components, which set can be a subset of all the fluidic components that can be comprised by the fluidic system 10. A flow path 12 can be defined by creating at least one fluidic connection between a subset of the fluidic components of the fluidic system 10. Typically, a flow path 12 can comprise an input fluidic component 1, which can also be referred to as an input node 1 or as a start node 1. The input fluidic component 1 can refer to the starting point of the flow within a flow path 12. That is, the input fluidic component 1 can provide fluid with a defined pressure and/or a defined flow rate. In other words, the input fluidic component 1 can be a fluidic component of the fluidic system 10 wherein a flow path 12 can initiate and which typically can facilitate introducing a fluid in the flow path 12 and/or into the fluidic system 10 with a defined pressure and/or a defined flow rate. For example, the input fluidic component 1 can be a fluidic actuator 1 (e.g. a pump, a high-pressure pump, a diaphragm pump, or a syringe pump). The fluidic actuator 1 can be configured to propel the fluid into the flow path 12.

Moreover, a flow path 12 can comprise an output fluidic component 7, which can also be referred to as an output node 7 or as an end node 7. The output fluidic component 7 can refer to points where a fluid can exit the flow path 12 and/or the fluidic system 10. For example, the output fluidic component 7 can be an outlet of the flow cell of an analytical detector, a needle of an autosampler and/or fluidic components that are connected to a waste (a) waster container(s). In such configurations, the output fluidic component 7 is a (or close to) ambient pressure.

For some flow paths 12, the output node 7 can be a blocked output 7. In this case a fluid may not exit the flow path 12. Such a flow path 12 may be created, by blocking a flow path 12, e.g., by switching a valve to a blocked state or by using a blind plug.

Typically, each flow path 12 can comprise an input fluidic component 1 and an output fluidic component 7, positioned on opposite extremities of the flow path 12, such that a fluid can flow in the flow path 12 from the input fluidic component 1 to the output fluidic component 7. The fluidic system 10 can be provided with one or more input fluidic components 1, wherein the one or more input fluidic components can uniquely correspond to a flow path 12 and/or can be shared by multiple flow paths 12. Similarly, the fluidic system 10 can be provided with one or more output fluidic components 7, wherein the one or more output fluidic components can uniquely correspond to a flow path 12 and/or can be shared by multiple flow paths 12.

In FIG. 1, the exemplary fluidic system 10 is depicted in the configuration corresponding to flow path 12A (depicted with a bold continuous line). In the depicted configuration, the fluidic system 10 can guide a fluid according to the flow path 12A. As illustrated by the alternative flow paths 12B and 12C, depicted with dashed and dotted lines, respectively, the fluidic system 10 can assume more than one configuration. For example, the fluidic system 10 can be configured such that a fluid can be guided according to flow path 12B or according to flow path 12C. Moreover, the fluidic system 10 can be configured such that it can change configurations. More particularly, the fluidic system 10 can be rendered from a first configuration (with a respective first flow path) to a second configuration (with a respective second flow path).

Rendering the fluidic system 10 in a certain configuration can comprise defining a flow path 12 that can correspond to that configuration. Moreover, defining a flow path 12 can comprise selecting a subset of the fluidic components of the fluidic system 10 to define the flow path 12. The fluidic system 10 can comprise one or more fluidic switches 2, which can facilitate defining a flow path 12. The fluidic switches 2 can also be referred to as valves 2. The fluidic switches 2 can facilitate selecting a subset of the fluidic components of the fluidic system 10, thus, defining a flow path 12. More particularly, the fluidic switches 2 can be configured to allow a fluid to flow in a selected set of fluidic components and to block the flow in the rest of the fluidic components.

For example, a fluidic switch 2 can comprise a plurality of ports. The fluidic switch 2 can be configured such that each of the ports can assume an open or a closed position. In an open position, a port can allow flow of a fluid through it. In a closed position, a port blocks the flow of a fluid through it.

In some embodiments, the fluidic switch 2 can be configured to allow a fluidic connection between at least two ports. This can allow a fluid to flow between the at least two connected ports. Moreover, the fluidic switch 2 can be configured to isolate two ports, thus, preventing a fluid from flowing between the isolated ports. Such a fluidic switch is described, for example, in U.S. Pat. No. 8,806,922 B2, referred therein as an injection valve.

Thus, in a particular embodiment, the fluidic switch 2 can comprise a rotor and a stator (not shown). The rotor can be pressed against the stator with a certain pressing force such that a common interface between the rotor and the stator can be formed, at which both components (i.e. rotor and stator) can be mutually sealed. In this case, the pressing force can be chosen sufficiently high such that the arrangement can also remain sealed at the highest pressures to be expected. The stator can feature a plurality of ports of the fluidic switch 2. The fluidic switch 2 can be connected to the other fluidic components of the fluidic system 10 via these ports (e.g. via capillary connections). The ports can be realized in the form of bores that can lead from one side of the stator to the other. The rotor can feature a number of grooves that can be exactly aligned with the bores of the ports. By rotating the rotor with respect to its central axis, the grooves can allow different pairs of ports to be fluidically connected to each other.

However, it will be understood that the fluidic switch 2 may also be implemented otherwise.

Referring to FIG. 1, each of the flow paths 12A, 12B and 12C can be defined by correspondingly arranging the fluidic switches 2A-2E. For example, the flow path 12A can be defined by arranging the fluidic switch 2A to establish a fluidic connection between fluidic components 8A and 8B, by arranging the fluidic switch 2B to establish a fluidic connection between fluidic components 8B and 8D, by arranging the fluidic switch 2C to establish a fluidic connection between fluidic components 8D and 8E and by arranging the fluidic switch 2D to establish a fluidic connection between the fluidic components 8E and 8G. Thus, of all the fluidic components of the fluidic system 10, the fluidic switches 2A to 2E allow selecting some of them (e.g. the fluidic components 8A, 8B, 8D, 8E, 8G, 7 in the first fluid path 12A). It will be understood that arranging a fluidic switch 2 to establish a fluidic connection between at least two fluidic components can comprise arranging the fluidic switch 2 such that a fluidic connection can be established between the respective ports of the fluidic switch 2 that the at least two fluidic components are connected to.

Further, it will be understood that the flow path 12B comprises the components 8A, 8C, 8E, 8J, 8H, and 7 (generally indicated by the dashed line) and that the flow path 12C comprises the components 8A, 8B, 8F, 8H, and 7.

In other words, between each input node 1 and output node 7 a number of n connections and thus flow paths 12 can exist (where n>1). Thereby, switching between different flow paths in a fluidic network 10 can occur at branching points by means of switching valves 2, as illustrated in FIG. 1.

To sum up, FIG. 1 illustrates a fluidic system 10 that can be part of a chromatography system. For example, the fluidic system 10 can be defined between one or more pumps (indicated in FIG. 1 by the letter P) and one or more analytical detectors (indicated in FIG. 1 by the letter D). Moreover, the fluidic system 10 can be configured for allowing fluid connections between the devices of the chromatography system, such as, sample vials, valves, pumps, columns, detectors, waste outlets, etc. More particularly, the fluidic system 10 can comprise a plurality of conduits (e.g. capillaries) that can guide fluids in certain ways, thus, realizing fluidic connections between the devices of the chromatography system. In the simplest form, the fluidic system 10 can comprise only one configuration, according to which a respective flow path 12 can be defined. For example, the single flow path of the fluidic system 10 can guide a fluid from one or more fluid container(s) towards one or more chromatography column(s). However, in some embodiments, the fluidic system 10 can be operable according to a plurality of configurations, wherein according to each configuration a respective flow path 12 can be defined. For example, in one configuration, a respective flow path can be defined allowing a sample to be received from a sample vial to a sample loop. In another configuration, another flow path can be defined allowing an elution solvent to be introduced into the flow path, such that the elution solvent with the sample can be introduced to a chromatography column. In yet another configuration, yet another flow path can be defined allowing a cleaning solution to flow through the flow path (e.g. sample loop) for cleaning the flow path before introducing another sample therein.

E.g., to prevent damage of the fluidic system 10 by the generic fluidic testing process, discussed above, the following aspect may be taken into account. For some fluidic components, such as trap columns, it may be advantageous to only be subjected to flow in one direction. Accordingly, the fluidic description of this component (i.e. the component characteristic) can contain the respective information. During the process of probing (i.e. applying a fluid with an input fluidic characteristic), the fluidic system is subjected to an input fluidic characteristic (e.g., pressure). E.g., to prevent damage to fluidic components, the pressure may be limited to a pressure limit of the respective component. Therefore, the fluidic model description of each component (i.e. the at least one component characteristic) can contain information regarding maximum operating conditions such as maximum pressure or maximum flow. It is noted that these pressure ratings may differ significantly between components. In addition, it is advantageous to consider the following parameters. The backpressure of a fluidic conduit is proportional to the viscosity of the fluid contained. This parameter is strongly temperature dependent. Thus, it is advantageous to consider the information about the temperature of any fluidic element. The backpressure is strongly dependent on the geometry of the fluidic element; particularly its given diameter. Thus, information about the typical (allowed) tolerances in dimension may be included.

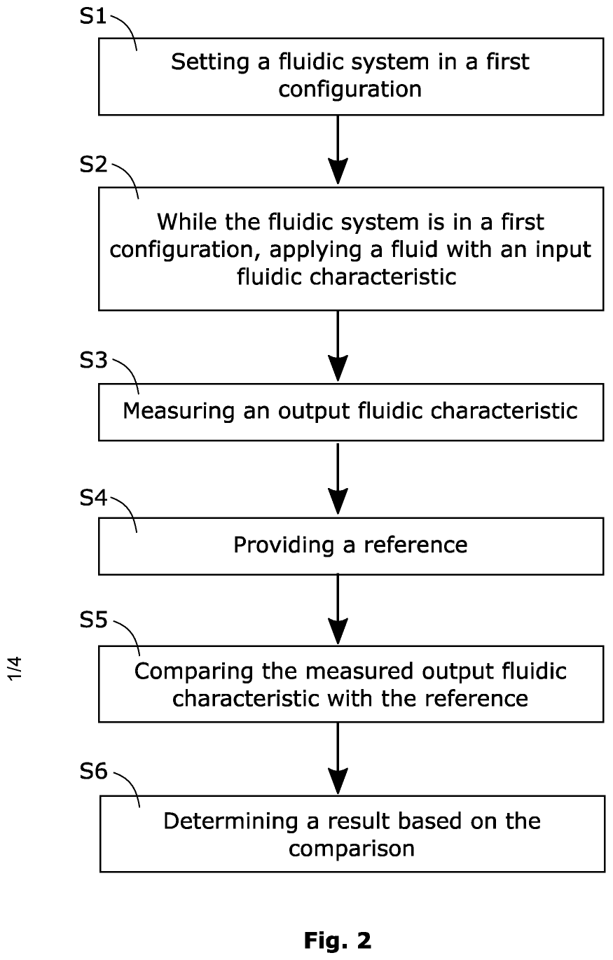

FIG. 2 illustrates a method of testing a fluidic system 10. More particularly, FIG. 2 illustrates a generic approach to characterize or test a given fluidic network 10 (such as an HPLC system). The presented approach can be assisted by or can utilize a fluidic description framework. This approach can allow for identification and location of issues of fluidic networks 10 such as blockages, leakages or misconfiguration (i.e. user errors).

The general principle of the method is similar to probing of electric circuits. Here, a flow path is subjected to a certain flow (or pressure) by a pump. Analogously to the electrical probing, the fluidic resistivity, i.e. the backpressure of the given flow path (subset of the fluidic system) can be determined. The actual (measured) backpressure of this flow path can be compared with an expected (calculated) backpressure value. Thus, a significant discrepancy between the actual and expected backpressure would be indicative of an issue related to this flow path.

More particularly, in a step S1 the method can comprise setting a fluidic system 10 in a first configuration. As discussed, this can comprise defining a flow path 12 in the fluidic system 10. Moreover, defining a flow path 12 can be facilitated by adjusting one or more fluidic switches 2 of the fluidic system 10. Alternatively or additionally, the flow path 12 can be defined by manually creating at least one fluidic connection (e.g., a plurality of fluidic connections) between a subset of the fluidic components of the fluidic system 10.

However, there may be some problems with a fluidic system. For example, the connections between the fluidic components may not be sufficiently tight or correctly performed, which can lead to leakages, wrong conduits (e.g. capillaries) can be used which can lead to different flow rates and/or pressures than expected, the defined flow path 12 can be clogged or a different flow path 12 can be defined (e.g. due to a user error), an incorrect fluid can be used, such as, an incorrect solvent can be used, e.g., the use of acetonitrile instead of water (which would lead to a lower viscosity and a lower fluidic resistance). As such, the operation of the fluidic system 10 can be non-optimal and/or can lead to erroneous results (e.g. erroneous chromatography results).

The present method can detect these issues by providing an approach for testing a fluidic configuration.

Moreover, a fluidic system 10, such as a fluidic system 10 of a chromatography system, can comprise a large variety of configurations. In light of this, the present method provides a generic approach for testing fluidic systems 10 (i.e. for detecting and/or locating issues in a fluidic system 10).

The present method achieves these objectives, by means of some or all of the following steps.

In a step S2, the method can comprise applying a fluid with an input fluidic characteristic while the fluidic system 10 is in the first configuration. That is, in step S2, the fluidic system 10 rendered in the first configuration can be probed. Applying a fluid with an input fluidic characteristic to the fluidic system 10 (i.e. probing the fluidic system 10) can comprise subjecting a flow path 12 defined in the fluidic system 10 to a fluidic flow, such that the fluid flow is according to the input fluidic characteristic.

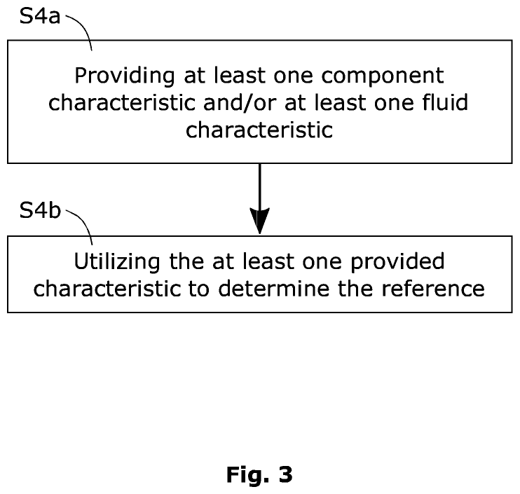

Typically, the input fluidic characteristic can be a flow rate or a pressure. That is, in step S2, the fluidic system 10 (more particularly the flow path 12 defined in the fluidic system) can be subjected to a fluidic flow with a certain and predetermined flow rate or pressure. In addition, in step S2 the fluid can be determined or the fluidic characteristic of the fluid can be known or provided (see step S4a in FIG. 3)

In a step S3, the method can comprise measuring an output fluidic characteristic. The output fluidic characteristic can indicate an operating condition of the fluidic system 10 when applying a fluid with an input fluidic characteristic. The output fluidic characteristic can be measured directly or indirectly (i.e. by measuring a feature indicative for the output fluidic characteristic). Step S3 can be facilitated by at least one sensor configured to measure the output fluidic characteristic and/or a feature indicative for the output fluidic characteristic. Thus, at least one sensor can be provided to the fluidic system 10. For example, the at least one sensor can be provided at the start node 1 of a flow path 12, such as, at the outlet of the pump used to apply the fluid with an input characteristic.

In some embodiments, the input fluidic characteristic can be a flow rate and the output fluidic characteristic can be a pressure of the fluid in the flow path 12. That is, in step S2 the fluid can be applied to the fluidic system with a certain (i.e. predetermined) flow rate. For example, a pump can be configured to provide a constant flow to the fluidic system 10 and more particularly to the flow path 12 defined therein. Depending on the backpressure of the flow path 12, the pressure in the flow path 12 can be at a certain value for the applied flow rate. In step S3 the pressure can be measured. The pressure can be measured directly (e.g. using a pressure sensor) or indirectly (i.e. measuring another quantity and deriving the pressure from that quantity). An example of an indirect pressure measurement is measuring a power consumption of the pump used to provide the flow and based thereon determining the pressure in the flow path 12. In general, any measurement directly or indirectly indicative of the pressure in the flow path 12 can be performed.

Alternatively, the input fluidic characteristic can be a pressure and the output fluidic characteristic can be a flow rate of the fluid in the flow path 12. That is, in step S2 the fluid can be applied to the fluidic system 10 with a certain (i.e. predetermined) pressure. For example, a pump can be configured to provide a predefined fluid (e.g. a fluid with known viscosity) to the fluidic system 10 and more particularly to the flow path 12 with a constant pressure. That is, the pressure at the outlet of the pump can be at a predefined value. Depending on the backpressure of the flow path 12 (i.e. on the fluidic resistivity of the flow path 12), the fluid provided with the predetermined pressure can flow in the flow path 12 with a respective flow rate. In step S3 the flow rate can be measured. The flow rate can be measured directly (e.g. using a flow rate sensor) or indirectly (i.e. measuring another quantity and deriving the flow rate from that quantity).

As discussed, according to one embodiment, measuring an output fluidic characteristic in step S3 can comprise determining a backpressure of a flow path 12 defined in the fluidic system 10. The actual (i.e. measured) backpressure of a flow path 12 can be the sum of the individual backpressures of all the fluidic elements that are contained in the flow path. That is,

ΔP_{act,p}=ΣᵢΔP_{act,i}

wherein ΔP_{act,p} refers to the actual (i.e. measured) backpressure of a flow path 12, ΔP_{act,i} refers to the actual backpressure of a fluidic component and i is an iterator traversing through the set of the fluidic components contained in the flow path 12.

The actual backpressure ΔP_{act,p} of a flow path 12 can be measured or determined based on a single measurement (i.e. without measuring or determining the actual backpressure ΔP_{act,i} of which fluidic component).

In a step S4, the method can comprise providing a reference. The reference can indicate a nominal (i.e. expected) operating condition of the fluidic system 10. More particularly, the reference can indicate what the output characteristic is expected to be, when applying the fluid with the input characteristic, while the fluidic system is in the first configuration.

FIG. 3 provides an exemplary approach of providing the reference in step S4. In a first sub-step S4a, providing the reference can comprise providing at least one component characteristic and/or at least one fluid characteristic. Each component characteristic can correspond to a respective fluidic component of the fluidic system 10 and can indicate a feature of the fluidic component. In other words, each fluidic component can comprise at least one component characteristic. Sub-step S4a can comprise providing, for each fluidic component of the flow path 12 that can be defined in step S1, the respective component characteristic(s).

Moreover, each component characteristic can comprise a component fluidic resistance and/or at least one feature indicative for the component fluidic resistance, respectively. For example, each component characteristic can comprise parameters describing the geometry (i.e. the shape) of the fluidic component and more particularly of a volume of the fluidic component that can be occupied by the fluid flowing through the flow path 12. Said parameter may include a shape and dimensions of the shape. In general, the component characteristic of a fluidic component may comprise at least one of flow length and flow cross section indication of the fluidic component.

Chromatography systems can be operated using chromatography data systems. An example of a chromatography data system is the Thermo Scientific™ Chromeleon™ Chromatography Data System (CDS) software.

In Chromeleon CDS, a fluidic framework may be established which allows to describe a fluidic configuration (i.e. the routing of fluidic connections within and between sub-systems/modules of a chromatography system) with good granularity. The Chromeleon CDS may be capable of describing the volume of fluid elements such as capillaries, columns and chromatography system components like valves (ports), mixers, flow cells etc.

Hence, in some embodiments of the present technology, the Chromeleon CDS may be used. Based thereon, one may calculate the nominal volume in any given flow path of the fluidic network.

Thus, in some embodiments, providing the component characteristics for each fluidic component can be facilitate by a chromatography data system.

The same flow path 12 can comprise different operating conditions depending on the fluid contained in the flow path 12. For example, different fluids can interact differently with the walls of the fluidic components of the flow path 12. This can depend on the dynamic viscosity of the fluid (which has units force×time/area). Thus, in addition to the component characteristics, which can indicate the geometry of the fluid components wherein the fluid can flow, in sub-step S4a, at least one fluid characteristic, such as, at least one intrinsic property of the fluid which is contained in the flow path 12, for example, the dynamic viscosity of the fluid, can be provided. Furthermore, the fluid characteristic, such as the dynamic viscosity, can depend on the temperature of the fluid. Thus, the fluid characteristic can be provided based on the temperature of the fluid.

In a second sub-step S4b, providing the reference can comprise utilizing the at least one provided characteristic (i.e. component characteristic and/or fluidic characteristic) to determine the reference. For example, the reference can be calculated as a function of the provided component characteristics and/or fluid characteristics. In addition, the reference can be determined based on the input fluidic characteristic. That is, the fluidic system 10 may comprise different operating conditions for different input characteristics. As such, when providing the reference, the input fluidic characteristic can be considered.

Thus, the reference can be provided based on the configuration of the fluidic system 10 and more particularly based on the component characteristics of the fluidic components contained in the flow path 12 defined in the fluidic system 10, the type of fluid flowing in the fluidic system, the temperature of the fluid, the input fluidic characteristic or any combination thereof.

In a particular embodiment, the reference can indicate an expected (i.e. nominal) backpressure of the flow path 12.

The nominal (calculated) backpressure ΔPₙₒₘ across a fluid conduit (element) can be calculated using the Hagen-Poiseuille equation:

ΔPₙₒₘ=8μLQ/πR⁴

wherein ΔPₙₒₘ is the backpressure drop across the fluid conduit, L is the length of the conduit (pipe), μ is the dynamic viscosity of the fluid flowing through the conduit, Q is the volumetric flow rate and R is the radius of the conduit (pipe).

While most of the parameters in the equation describe the geometry of the fluidic conduit, the dynamic viscosity p is an intrinsic property (i.e. a fluidic characteristic) of the fluid which is contained in the flow path. The viscosity of the fluid is strongly dependent on the temperature of the fluid. Therefore, the step of providing the reference can further depend on the temperature value of each fluid component. However, in a typical use case, most elements will be at room temperature, whilst element in a thermostated column compartment (TCC), such as preheaters, columns, element in flowmeters, are at an elevated and controlled temperature. In other words, the temperature of the fluidic components in a fluidic system 10 can typically be known or controlled. However, in some embodiments, the method can further comprise measuring the temperature of the fluid. This can be performed, e.g., in step S3 or in step S4.

It will be noted that the Hagen-Poiseuille equation is only an exemplary relation that can be used to determine analytically the nominal backpressure of a fluidic component. The Hagen-Poiseuille equation can typically be used to calculate the backpressure of fluidic components that comprise a cylindrical shape, such as, conduits, pipes and capillaries. Other relations can be used as well for calculating the nominal backpressure of a fluidic component. For example, the Kozeny-Carman equation can be used to calculate the backpressure of packed bed fluidic components, such as, chromatography columns.

The nominal backpressure of an arbitrary nominal flow path ΔP_{nom,p} can be determined as the sum of all backpressure values ΔP_{nom,i} of all fluid elements i that are contained in this flow path:

ΔP_{nom,p}=ΣᵢΔP_{nom,i}

In a next step S5 (see again FIG. 2), the method can comprise comparing the output fluidic characteristic with the reference. As discussed, the output fluidic characteristic can indicate an actual operating condition of the fluidic system 10 in a first configuration, when applying a fluid with an input fluidic characteristic. On the other hand, the reference can indicate an expected operating condition of the fluidic system 10 in the first configuration, when applying the fluid with the input fluidic characteristic. Thus, step S5 facilitate comparing the actual fluidic configuration with a nominal fluidic configuration.

In the following, a particular example of performing step S5 will be discussed. For validation of the correctness of an actual fluidic configuration of the fluidic system 10, the actual (i.e. measured) backpressure value of any arbitrary flow path defined in the fluidic system 10 can be compared to its respective nominal backpressure value. That is, in this example, the output fluidic characteristic and the reference relate to the measured and expected backpressure of the flow path 12, respectively. However, it will be understood that the output fluidic characteristic and the reference can relate to other fluidic characteristics of the flow path 12, such as the measured and expected flow rate respectively. In any case, the comparison of the output fluidic characteristic and the reference in step S5 can be similar to the comparison illustrated below.

To facilitate comparing the nominal backpressure (i.e. reference) with the measured backpressure (i.e. output fluidic characteristic), a discrepancy margin ΔP_{dis} can be used. The discrepancy margin can be the difference between the actual backpressure ΔP_{act} and the nominal backpressure ΔPₙₒₘ of a given flow path or component, as given below:

ΔP_{dis}=ΔP_{act}−ΔPₙₒₘ.

Thus:

ΔP_{act}=ΔPₙₒₘ+ΔP_{dis}

It should be noted that the difference between the actual backpressure ΔP_{act} and the nominal backpressure ΔP_{act} can be a positive or a negative value. Moreover, the difference can vary between different types of conduits. For simplicity, the discrepancy margin can be expressed as a percentage value of the actual backpressure ΔP_{act}.

To allow for identification of a significant discrepancy between expected and actual fluidic configuration a threshold margin ΔP_{lim,j} can be defined for each fluidic configuration j (i.e. for each flow path). The threshold margin can facilitate accounting for non-ideal properties of the actual fluid conduits, such as geometric tolerances or temperature differences and local variation in viscosity. The threshold margin ΔP_{lim,j} essentially is the maximum allowed deviation of actual backpressure from nominal backpressure. Thus when a flow path j is tested and the absolute value of ΔP_{dis,j} for that flow path is exceeding the threshold margin ΔP_{lim,j} for this flow path j, this discrepancy between expected and actual fluidic configuration can be indicative of an issue related to this flow path j. That is, an issue can be present in a flow path j, if the discrepancy margin is larger than threshold margin, i.e., if the following relation holds:

|ΔP_{dis,j}|>|ΔP_{lim,j}|

In the above, symmetric discrepancy margin for backpressure value below and above ΔPₙₒₘ was considered. Thus, the threshold margin was identical for lower and upper thresholds:

ΔP_{lim,lower}<ΔP_{dis}<ΔP_{lim,upper}

where

−ΔP_{lim,lower}=ΔP_{lim,upper}

That is, ΔP_{lim,lower} is a negative lower limit, and ΔP_{lim,upper} is a positive upper limit.

Further, in a step S6, the method can comprise determining a result based on the comparison. The result can indicate the presence of a fluidic issue in the fluidic system 10. More particularly, the result can indicate, e.g., a leakage or a blockage in the fluidic system 10 or a misconfiguration of the fluidic system 10.

Thus, continuing the above example, in the case where the deviation from the nominal backpressure (i.e. discrepancy margin) is smaller than the lower threshold margin, this abnormally low backpressure can be indicative of a leakage or a conduit with significantly larger inner diameter than intended. This can be the case when

ΔP_{dis}<ΔP_{lim,lower}

Likewise, in the case where the deviation from the nominal backpressure (i.e. discrepancy margin) is greater than the upper threshold margin, this abnormally high backpressure might be indicative of a blockage or a conduit with significantly smaller inner diameter than intended. This can be the case when

ΔP_{dis}>ΔP_{lim,upper}

Again with primary reference to FIG. 1, an illustrative example will be discussed. As discussed, the first flow path 12A is depicted by the solid line and comprises fluidic components 8A, 8B, 8D, 8E, 8G, and 7. The system may assume a configuration where the first flow path is defined, i.e., a fluid may flow from the fluidic actuator 1 to the output node 7, which may, e.g., be connected to a detector D. While assuming this configuration, the fluidic actuator may cause the fluid to flow with an input fluidic characteristic, e.g., with a defined flow rate. As a mere example, the fluidic actuator may apply a flow rate of 1 ml/min. Based on the fluid that flows through the system, the flow rate, and the temperatures of the individual components 8A, 8B, 8D, 8E, 8G, and 7, an expected pressure loss at each of the components may be calculated, and adding these expected pressure losses leads to a total expected pressure loss. Further to the above examples, the total expected pressure loss for the first flow path 12A may be, e.g., 400 bar when a flow rate of 1 ml/min is applied. In the present technology, an output fluid characteristic, e.g., a total back pressure, may be measured. Continuing in the above example, if the measured total back pressure is, e.g., 300 bar, it is lower than the total expected pressure loss, which may be indicative for a leakage. If, however, the measured total back pressure is, e.g., 500 bar, it is higher than the total expected pressure loss, which may be indicative, e.g., of a blockage.

Continuing with the above example where a total back pressure of 300 bar (which may indicate a leakage) was measured, the system may also be switched to another configuration, e.g., to a configuration where the third flow path 12C is established, which is defined by fluidic components 8A, 8B, 8F, 8H, and 7. Again, also in this configuration, a flow with a defined flow rate (e.g., 1 ml/min for sake of simplicity) may be applied, and a total back pressure may be measured. Following the above rationales, a total expected pressure loss may be determined, which may be, e.g., 500 bar, and compared to the measured total back pressure. If the measured back pressure is below the total expected pressure loss in this configuration (e.g., 400 bar instead of the expected 500 bar), this may again indicate a leakage. In such a scenario, it may be likely that the leakage occurs in fluidic component 8A, 8B, or 7, as these components are present both in the first flow path and in the third flow path.

Further continuing the above example, the system may be set to a still further configuration where the flow path 12B is defined (which comprises components 8A, 8C, 8E, 8J, 8H, and 7. Again, also in this configuration, a flow rate may be applied by means of the actuator 1 (e.g., again 1 ml/min), and a measured total back pressure may be compared to an expected total back pressure. If, e.g., these two correspond relatively closely to one another (e.g., in case the expected total back pressure is 450 bar and the measured total back pressure is 452 bar), this may indicate that (within the error margins) the system works well in this configuration, so that there is likely no issue in this configuration. Thus, it can be inferred that there is no issue in the components 8A, 8C, 8E, 8J, 8H, and 7.

In such a scenario, the present technology may thus locate a potential leakage in component 8B, as the leakage was detected in flow path 12A and 12C (both comprising element 8B), but not in flow path 12B (not comprising this element).

This illustrates how the present technology can be used to detect and locate fluidic issues.

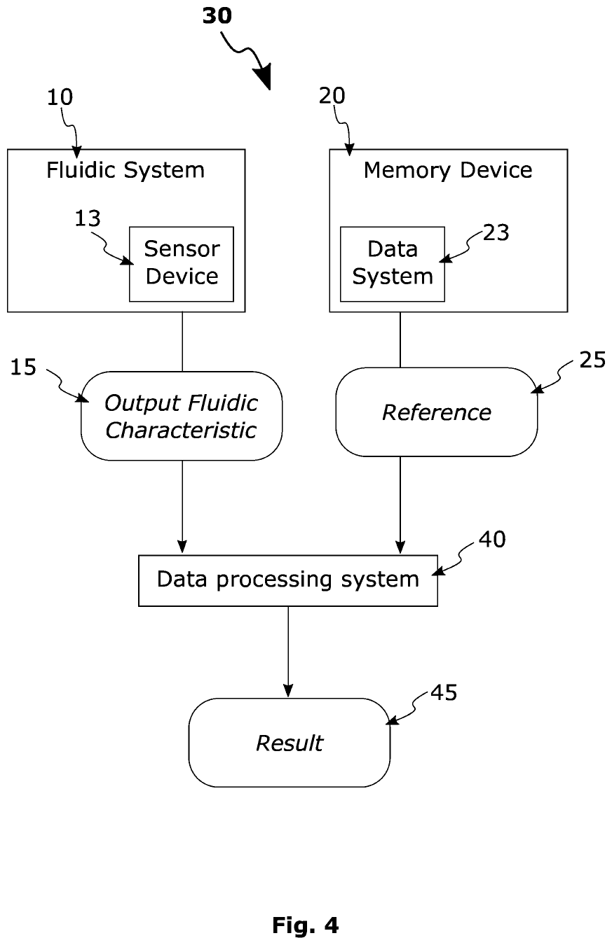

FIG. 4 illustrates a testing system 30 configured for testing a fluidic system. The testing system 30 can comprise a fluidic system 10 (i.e. the fluidic system to be tested). For example, the fluidic system 10 can be as described with reference to FIG. 1.

In addition, the testing system 30 can comprise at least one sensor device 13. The at least one sensor device 13 can, for example, be integrated into the fluidic system 10. As also discussed above, the sensor device(s) 13 can be provided at the outlets of the fluidic actuators 1 of the fluidic system 10. Furthermore, the at least one sensor device 13 can facilitate performing measurements of the fluidic system 10. More particularly, the at least one sensor device 13 can be configured for measuring the output fluidic characteristic 15. The at least one sensor device 13 can be configured for measuring a pressure and/or flow rate of a fluid flowing in the fluidic system 10. Alternatively, the at least one sensor device 13 can be configured for measuring a feature indicative for the pressure and/or flow rate of a fluid flowing in the fluidic system 10 (e.g. a power consumption of a fluidic actuator). In a preferred embodiment, the at least one sensor device 13 can be configured to perform a measurement for facilitating the determination of the backpressure of a flow path 12 in the fluidic system.

In other words, the at least one sensor device 13 can be configured to facilitate performing step S3 of the method discussed with reference to FIGS. 3 and 4.

The testing system 30 can further comprise a memory device 20. The memory device 20 may be singular or plural, and may be, but not limited to, a volatile or non-volatile memory, such as a random access memory (RAM), Dynamic RAM (DRAM), Synchronous Dynamic RAM (SDRAM), static RAM (SRAM), Flash Memory, Magneto resistive RAM (MRAM), Ferroelectric RAM (F-RAM), or Parameter RAM (P-RAM).

A data system 23 can be stored on the memory device 20. The data system 23 can comprise computer instructions for controlling the fluidic system 10. More particularly, the fluidic system 10 can comprise one or more automatic control functions, which can facilitate setting the fluidic system in a respective configuration. The automatic control functions may comprise setting the state of the fluidic switches 2, switching the fluidic actuators on or off, selecting a sample vial comprising a sample to be introduced into the fluidic system, setting one or more chromatographic settings or parameters or any combination thereof. The computer instructions of the data system 23 can facilitate using the automatic control functions. Moreover, the data system 23 may feature a graphical user interface that can facilitate a user to select or activate the computer instructions.

In addition, the data system 23 may comprise descriptive data of the fluidic system 10 and more particularly of the fluidic components that can be comprised by the fluidic system 10. For example, the data system 23 may comprise a database of fluidic components that can be used by the fluidic system and associated to each component, the data system 23 can comprise specification data (e.g. component characteristics) of that components.

For example, the data system 23 can be based on the Chromeleon™ Chromatography Data System (CDS) software developed by Thermo Scientific™.

The memory device 20 and more particularly the data system 23 can facilitate obtaining a reference 25. More particularly, the memory device and the data system 23 can facilitate performing step S4 of the method discussed with reference to FIGS. 2 and 3.

The testing system 30 can further comprise a data processing system 40. The data processing system 40 may be single processor or a plurality of processors, and may be, but not limited to, a CPU (central processing unit), GPU (graphical processing unit), DSP (digital signal processor), APU (accelerator processing unit), ASIC (application-specific integrated circuit), ASIP (application-specific instruction-set processor) or FPGA (field programmable gate array). The data processing system 40 may comprise one or more processor devices that can be locally located or distributed. Moreover, the data processing system 40 can comprise one or more cloud computing unit(s).

The data processing system 40 can be configured for obtaining the output fluidic characteristic 15 from the at least one sensor device 13. Furthermore, the data processing system 40 can be configured to control each of the at least one sensor device 13 for performing a measurement of the fluidic system 10. In some embodiments, the data processing system 40 can be configured to obtain the output fluidic characteristic 15 by obtaining sensor data that can be output by the at least one sensor device 13 after performing measurement and based thereon determining the output fluidic characteristic 15.

Furthermore, the data processing system 40 can be configured for accessing the memory device 20. As such, the data processing system 40 can obtain the reference 25. In some embodiments, data processing system 40 can obtain the reference 25 by obtaining component characteristics and/or fluid characteristics from the memory device 20 (e.g. from the data system 23 stored therein) and then utilizing those to calculate the reference 25.

In some embodiments, the data processing system 40 can execute the control instructions that can be comprised by the data system 23. This can facilitate automatically controlling the fluidic system 10 (i.e. activating the automatic control functions of the fluidic system 10). For example, the data processing system 40 can facilitate setting the fluidic system in a certain configuration (e.g. step S1 of the method illustrated FIG. 2) and/or applying a fluid with an input fluidic characteristic to the fluidic system (e.g. see step S2 of the method illustrated in FIG. 2).

In addition, the data processing system 40 can be configured for comparing the output fluidic characteristic 15 with the reference 25. The comparison can, for example, be performed as discussed with reference to step S5 of the method illustrated in FIG. 2. Based on the comparison, the data processing system 40 can determine or generate a result 45, e.g., as discussed with reference to step S6 of the method illustrated in FIG. 2.

The testing system 30 discussed above and illustrated in FIG. 4 can be particularly advantageous for carrying out the method discussed with reference to FIGS. 2 and 3. That is, the testing system 30 can be particularly advantageous for testing a fluidic system, such as, the fluidic system 10 discussed with reference to FIG. 1.

Whenever a relative term, such as “about”, “substantially” or “approximately” is used in this specification, such a term should also be construed to also include the exact term. That is, e.g., “substantially straight” should be construed to also include “(exactly) straight”.

It should also be understood that whenever reference is made to an element this does not exclude a plurality of said elements. For example, if something is said to comprise an element it may comprise a single element but also a plurality of elements.

Whenever steps were recited in the above or also in the appended claims, it should be noted that the order in which the steps are recited in this text may be accidental. That is, unless otherwise specified or unless clear to the skilled person, the order in which steps are recited may be accidental. That is, when the present document states, e.g., that a method comprises steps (A) and (B), this does not necessarily mean that step (A) precedes step (B), but it is also possible that step (A) is performed (at least partly) simultaneously with step (B) or that step (B) precedes step (A). Furthermore, when a step (X) is said to precede another step (Z), this does not imply that there is no step between steps (X) and (Z). That is, step (X) preceding step (Z) encompasses the situation that step (X) is performed directly before step (Z), but also the situation that (X) is performed before one or more steps (Y1), . . . , followed by step (Z). Corresponding considerations apply when terms like “after” or “before” are used.

While in the above, a preferred embodiment has been described with reference to the accompanying drawings, the skilled person will understand that this embodiment was provided for illustrative purpose only and should by no means be construed to limit the scope of the present invention, which is defined by the claims.

Furthermore, reference numbers and letters appearing between parentheses in the claims, identifying features described in the embodiments and illustrated in the accompanying drawings, are provided as an aid to the reader as an exemplification of the matter claimed. The inclusion of such reference numbers and letters is not to be interpreted as placing any limitations on the scope of the claims.

What is claimed is:

1. A method of testing a fluidic system, the method comprising
while the fluidic system is in a first configuration, applying a fluid with an input fluidic characteristic to the fluidic system and measuring an output fluidic characteristic; and
a data processing system comparing the measured output fluidic characteristic to a reference.

2. The method of claim 1,
wherein the input fluidic characteristic is a flow rate and the output fluidic characteristic is a pressure or wherein the input fluidic characteristic is a pressure and the output fluidic characteristic is a flow rate.

3. The method of claim 1, wherein a first flow path is defined in the first fluidic configuration, the first flow path comprising a first set of fluidic components, wherein each fluidic component comprises at least one component characteristic, respectively.

4. The method of claim 3, wherein each of the at least one component characteristic respectively comprises a component fluidic resistance, at least one feature indicative for the component fluidic resistance or any combination thereof.

5. The method of claim 3,
wherein measuring an output fluidic characteristic comprises measuring an output fluidic characteristic corresponding to the first flow path, and
wherein measuring an output fluidic characteristic corresponding to the first flow path comprises determining a backpressure of the first flow path.

6. The method of claim 1, wherein the method comprises providing the reference and
wherein providing the reference comprises providing the reference to the data processing system.

7. The method of claim 6, wherein providing the reference comprises determining the reference and wherein the data processing system determines the reference.

8. The method of claim 7, wherein a first flow path is defined in the first fluidic configuration, the first flow path comprising a first set of fluidic components, wherein each fluidic component comprises at least one component characteristic, respectively, and determining the reference comprises utilizing the at least one component characteristic for each fluidic component in the first set of fluidic components to determine the reference.

9. The method of claim 8, wherein determining the reference comprises calculating a nominal backpressure of the first flow path.

10. The method of claim 1, wherein measuring an output fluidic characteristic comprises measuring the output fluidic characteristic with at least one sensor device configured to measure the output fluidic characteristic, a feature indicative of the output fluidic characteristic or any combination thereof.

11. The method of claim 1, wherein comparing the measured output fluidic characteristic to a reference comprises
calculating a distance metric between the measured output fluidic characteristic and the reference,
defining a lower threshold margin and/or an upper threshold margin, and
comparing the distance metric to the lower threshold margin and/or to the upper threshold margin.

12. The method of claim 1, wherein the method further comprises determining a result based on the comparison and wherein determining a result comprises at least one of detecting and locating a difference between the first configuration and an expected configuration.

13. A testing system (30) configured for testing a fluidic system (10), the testing system (30) comprising
at least one sensor device (13) configured to facilitated measuring an output fluidic characteristic (15);
a data processing system (40) configured to obtain the output fluidic characteristic (15) and a reference (25) and compare the output fluidic characteristic (15) with the reference (25).

14. The testing system (30) of claim 13, wherein the testing system (30) further comprises a memory device (20) and
wherein the memory device (20) is configured to store a data system (23), and
wherein the fluidic system (10) comprises a plurality of fluidic components, each comprising a respective volume that can be occupied by a fluid flowing in the fluidic system (10), wherein each fluidic component comprises at least one component characteristic, respectively, and
wherein the data system is configured to store the at least one component characteristic of each fluidic component.

15. The testing system (30) of claim 14 wherein the data processing system (40) is configured to
obtain the reference (25) by obtaining component characteristics and/or fluid characteristics from the memory device 20 and then utilizing those to calculate the reference (25) and
obtain the output fluidic characteristic (15) by obtaining sensor data outputted by the at least one sensor device (13) after performing measurement and based thereon determining the output fluidic characteristic (15) and
generate a result (45) based on the comparison.
